(19) United States
(12) Patent Application Publication
(10) Pub. No.: US 2013/0264005 A1
(43) Pub. Date: Oct. 10, 2013

(54) METHOD FOR MAKING ASSEMBLED VENTILATION CLOTH OF NON-SEWING

(71) Applicant: SU-FANG OU, Taichung City (TW)

(72) Inventor: SU-FANG OU, Taichung City (TW)

(21) Appl. No.: 13/442,096

(22) Filed: Apr. 9, 2012

(51) Int. Cl. B32B 37/02; B32B 37/06

(52) U.S. Cl. 156/148

(57) ABSTRACT

A method for making assembled ventilation cloth of non-sewing utilizes a non-woven fabric for a vamp made by weaving a plurality of woven yarn in different directions and leaving a plurality of vacancies among the woven yarn for forming ventilation holes on the non-woven fabric. Pieces of assembled cloth are arranged on the non-woven fabric and firmly attached to the non-woven fabric via a heating roller. A piece of net cloth with larger meshes makes a bottom surface thereof covered with glue so that the net cloth is attached to a surface of the assembled cloth. Accordingly, effects of rapid production and nice ventilation are achievable.

### BACKGROUND OF THE INVENTION

1. Field of the Invention

The present invention relates to a method for making assembled ventilation cloth of non-sewing, especially to pieces of assembled cloth that are attached to a non-woven fabric for a vamp via a heating roller, subsequently putting a piece of net cloth on the pieces of assembled cloth. Accordingly, the method results in rapid production and nice ventilation.

2. Description of the Related Art

A piece of ventilation cloth is commonly adopted for making a ventilation vamp. Wherein, a piece of net cloth with large meshes is attached to a surface of the ventilation cloth, thereby allowing pieces of patterned cloth to be properly sewn on a combination of the ventilation cloth and the net cloth for contributing to a formal vamp. Herein, the sewing process is in fact laborious and difficult. Therefore, the productivity can not be high, and the conventional process costs a lot.

### SUMMARY OF THE INVENTION

1. A main object of the present invention is to provide a method for making assembled ventilation cloth of non-sewing. Characterized in that, a non-woven fabric for a vamp is made by weaving a plurality of woven yarn in different directions and leaving a plurality of vacancies among the plurality of woven yarn for forming ventilation holes on the non-woven fabric. Pieces of assembled cloth in different shapes and colors are arranged corresponding to predetermined positions on the non-woven fabric. The assembled cloth and the non-woven fabric are made of the same material and combined by a heating roller. A piece of net cloth with larger meshes makes a bottom surface thereof covered with glue so that the net cloth is attached to the pieces of assembled cloth. The pieces of assembled cloth with different shapes are arranged on the non-woven fabric correspondingly to predetermined positions. Any part on the non-woven fabric that is not covered becomes a ventilation part. A knit plane is formed on a junction of any two pieces of assembled cloth. The pieces of assembled cloth are melted and softened by the heating roller for attaching to the non-woven fabric. The net cloth is attached to a second surface of the pieces of assembled cloth, thereby achieving effects of rapid production and nice ventilation.

2. Another object of the present invention is to provide a method for making assembled ventilation cloth of non-sewing. Characterized in that, the pieces of assembled cloth with different shapes are properly arranged on predetermined positions on the non-woven fabric. An overlapping bulge is formed on a junction of any two pieces of assembled cloth. The pieces of assembled cloth in different thickness and divergent shape are arranged on the non-woven fabric, correspondingly to predetermined positions. A knit bulge is formed on a junction of a thicker piece of assembled cloth and a thinner piece of assembled cloth. The non-woven fabric and the pieces of assembled cloth are melted and softened by the heating roller for attaching to each other. The net cloth accordingly rises and falls on the pieces of assembled cloth to present a solid effect.

3. A further object of the present invention is to provide a method for making assembled ventilation cloth of non-sewing. Characterized in that, the pieces of assembled cloth with different shapes are properly arranged on the non-woven fabric, correspondingly to predetermined positions. The non-woven fabric and the pieces of assembled cloth are melted and softened via the heating roller so as to combine. The net cloth is further attached to the second surface of the pieces of assembled cloth. At least one piece of assembled cloth is attached to a third surface of the net cloth. Accordingly, the method provides rapid production. Moreover, nice ventilation on a part of the vamp is also contributed.

### BRIEF DESCRIPTION OF THE DRAWINGS

FIG. 1 is a perspective view showing a non-woven fabric for a vamp of the present invention;

FIG. 1-A is an enlarged view showing woven yarn of the present invention;

FIG. 2 is an exploded view of the present invention;

FIG. 2-A is a flowchart for combining the non-woven fabric with pieces of assembled cloth of the present invention;

FIG. 3 is a perspective view of the present invention;

FIG. 3-A is a cross-sectional view showing a knit plane on a junction of any two pieces of assembled cloth of the present invention;

FIG. 3-B is a cross-sectional view showing an overlapping bulge on a junction of any two pieces of assembled cloth of the present invention;

FIG. 3-C is a cross-sectional view showing a knit bulge on a junction of any two pieces of assembled cloth of the present invention;

FIG. 3-D is a cross-sectional view showing the assembled cloth being attached to the net cloth; and

FIG. 4 is a perspective view showing a shoe made in accordance with the present invention.

### DETAILED DESCRIPTION OF THE PREFERRED EMBODIMENTS

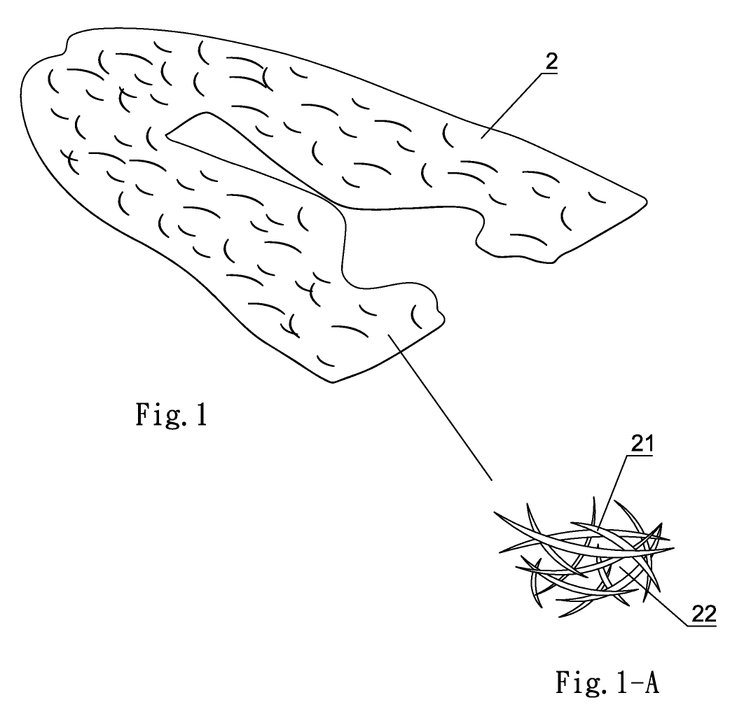

Referring to FIGS. 1 to 3 and FIGS. 1-A and 2-A, a non-woven fabric 2 is made of Thermoplastic Polyurethanes or other like Thermoplastic resin. The non-woven fabric 2 for a vamp is made by weaving a plurality of woven yarn 21 in different directions and leaving a plurality of vacancies among the plurality of woven yarn 21 for forming ventilation holes 22 on the non-woven fabric 2. Pieces of assembled cloth 3 in different shapes and colors are arranged corresponding to predetermined positions on the non-woven fabric 2. The assembled cloth 3 and the non-woven fabric 2 are made of the same material, such as Thermoplastic Polyurethanes or other like Thermoplastic resin. The pieces of assembled cloth are melted and softened by a heating roller 5 for attaching to a first surface of the non-woven fabric 2. A piece of net cloth 4 with larger meshes makes a bottom surface thereof covered with glue so that the net cloth 4 is attached to a second surface of the pieces of assembled cloth 3. By means of afore structure, effects of rapid production and nice ventilation are achieved.

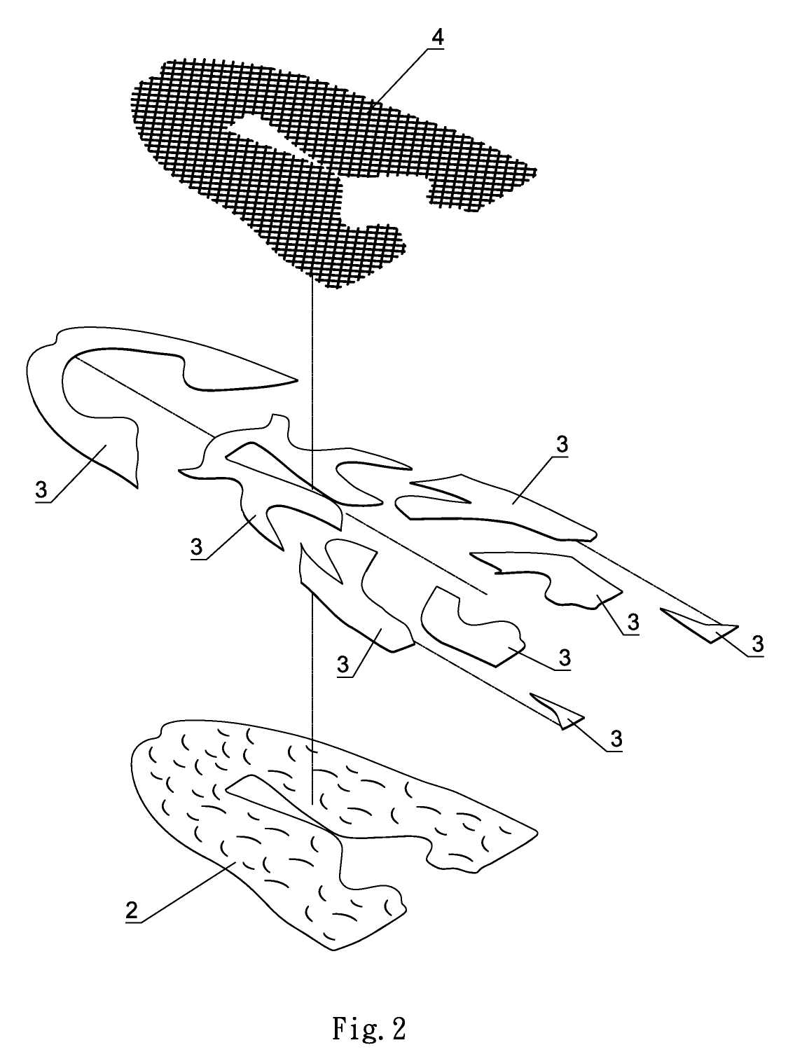

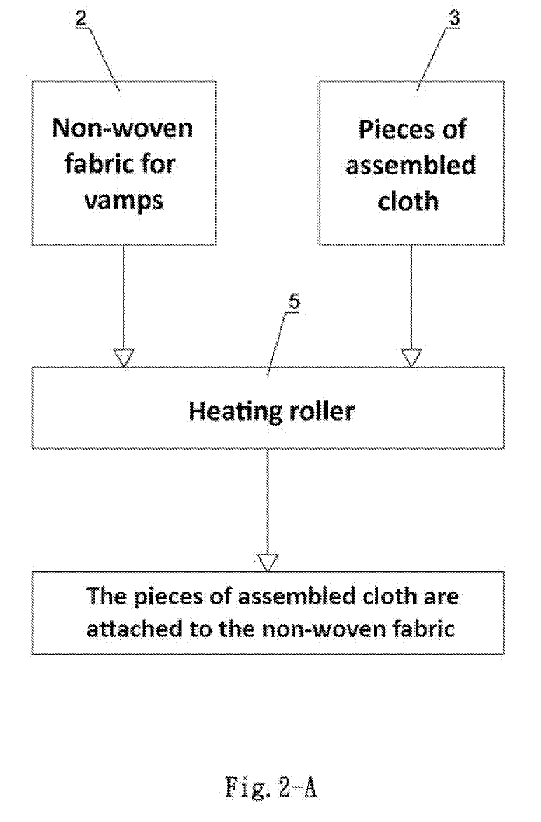

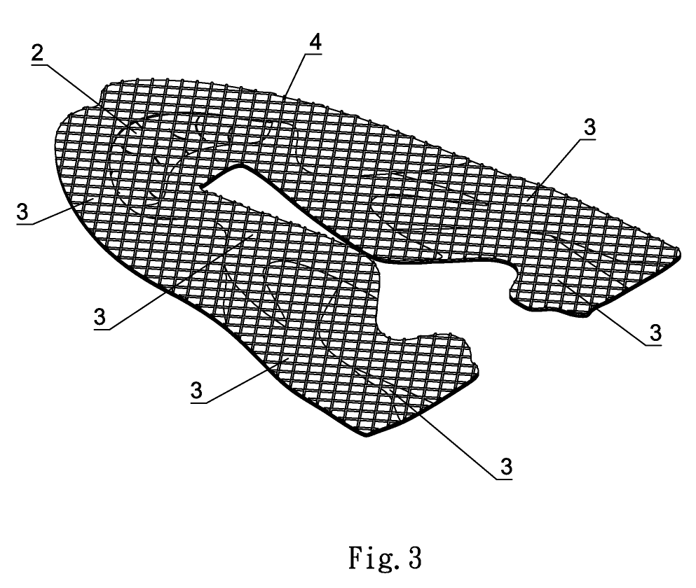

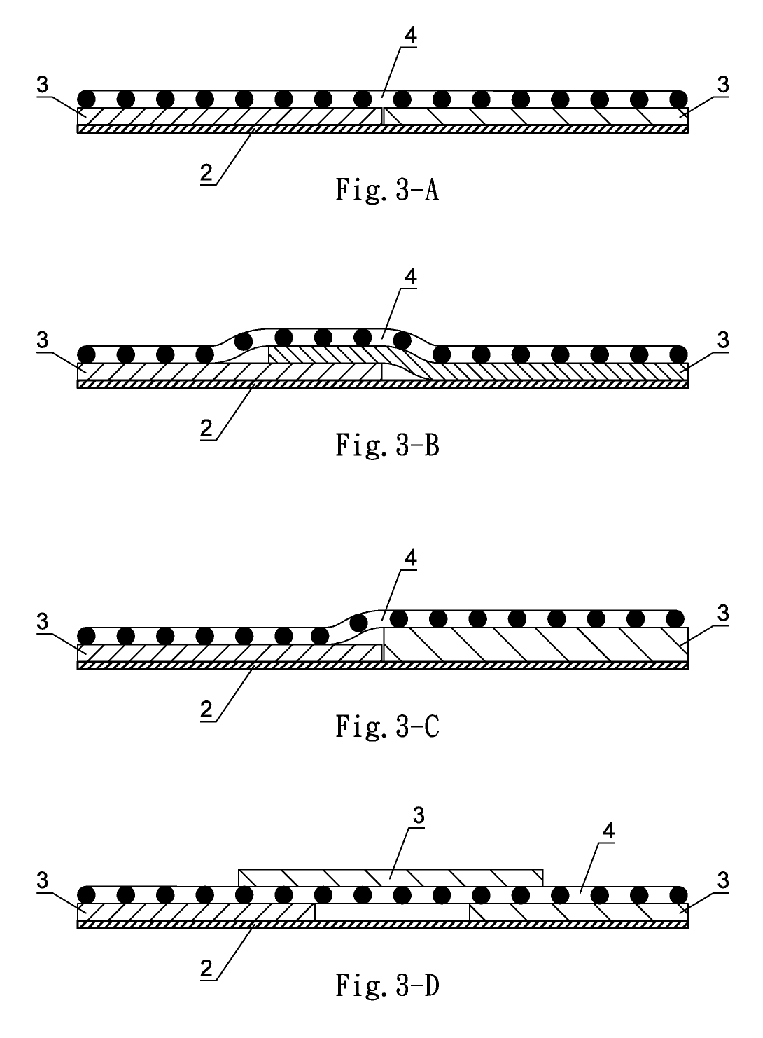

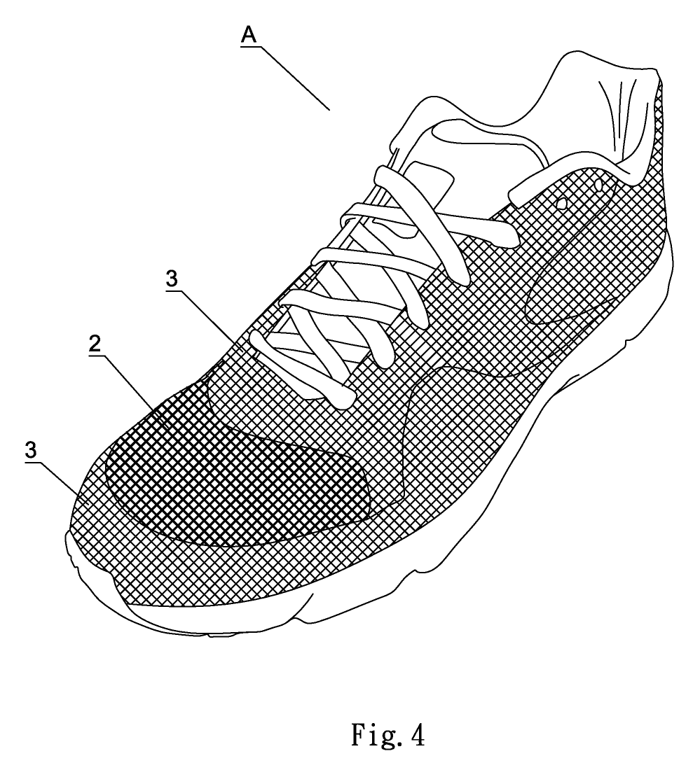

Referring to FIGS. 2 to 4 and FIG. 3-A, a first preferred embodiment of the present invention is shown. The pieces of assembled cloth 3 with different shapes and divergent colors are arranged on the non-woven fabric 2 correspondingly to predetermined positions. Any part on the non-woven fabric 2 that is not covered becomes a ventilation part (as shown in FIG. 3). A knit plane is formed on a junction of any two pieces of assembled cloth 3. The pieces of assembled cloth 3 are melted and softened by the heating roller 5 for attaching to the non-woven fabric 2. The net cloth 4 with larger meshes makes a bottom surface thereof covered with glue so that the net cloth 4 is attached to the second surface of the pieces of assembled cloth 3 (as shown in FIG. 3-A), thereby contributing to a shoe A (as shown in FIG. 4) and achieving effects of rapid production and nice ventilation.

Referring to FIGS. 3 to 4 and FIG. 3-B, a second preferred embodiment of the present invention is shown. The pieces of assembled cloth 3 with different shapes and divergent colors are arranged on the non-woven fabric 2 correspondingly to predetermined positions. Any part on the non-woven fabric 2 that is not covered becomes a ventilation part (as shown in FIG. 3). An overlapping bulge is formed on a junction of any two pieces of assembled cloth 3. The pieces of assembled cloth 3 are melted and softened by the heating roller 5 for attaching to the non-woven fabric 2. The net cloth 4 with larger meshes makes a bottom surface thereof covered with glue so that the net cloth 4 is attached to the second surface of the pieces of assembled cloth 3 (as shown in FIG. 3-B). The net cloth 4 accordingly rises and falls on the pieces of assembled cloth 3 to present a shoe A (as shown in FIG. 4) with a solid effect.

Referring to FIGS. 3 to 4 and FIG. 3-C, a third preferred embodiment of the present invention is shown. The pieces of assembled cloth 3 with different shapes and divergent colors are arranged on the non-woven fabric 2 correspondingly to predetermined positions. Any part on the non-woven fabric 2 that is not covered becomes a ventilation part (as shown in FIG. 3). A knit bulge is formed on a junction of a thinner piece of assembled cloth 3 and a thicker piece of assembled cloth 3. The pieces of assembled cloth 3 are melted and softened by the heating roller 5 for attaching to the non-woven fabric 2. The net cloth 4 with larger meshes makes a bottom surface thereof covered with glue so that the net cloth 4 is attached to the second surface of the pieces of assembled cloth 3 (as shown in FIG. 3-C). The net cloth 4 accordingly rises and falls on the pieces of assembled cloth 3 to present a shoe A (as shown in FIG. 4) with a solid effect.

Referring to FIGS. 3 to 4 and FIG. 3-D, a fourth preferred embodiment of the present invention is similar to the first preferred embodiment. The pieces of assembled cloth 3 with different shapes and divergent colors are arranged on the non-woven fabric 2 correspondingly to predetermined positions. Any part on the non-woven fabric 2 that is not covered becomes a ventilation part (as shown in FIG. 3). The pieces of assembled cloth 3 are melted and softened by the heating roller 5 for attaching to the non-woven fabric 2. The net cloth 4 with larger meshes makes a bottom surface thereof covered with glue so that the net cloth 4 is attached to the second surface of the pieces of assembled cloth 3. At least one piece of assembled cloth 3 is attached to a third surface of the net cloth 4 (as shown in FIG. 3-D), thereby contributing to a shoe A (as shown in FIG. 4). Accordingly, effects of convenient manufacturing and nice ventilation are achieved.

Aforesaid net cloth 4 is similarly made of Thermoplastic Polyurethanes or other like Thermoplastic resin. Whereby, the net cloth 4 is attached to the second surface of the pieces of assemble cloth 3 so as to further combine with the non-woven fabric 2 to present an integral directly via the heating roller.

While we have shown and described the embodiment in accordance with the present invention, it should be clear to those skilled in the art that further embodiments may be made without departing from the scope of the present invention.

I claim:

1. A method for making assembled ventilation cloth of non-sewing, characterized in that a non-woven fabric for a vamp is made by weaving a plurality of woven yarn in different directions and leaving a plurality of vacancies among said plurality of woven yarn for forming ventilation holes on said non-woven fabric; pieces of assembled cloth in different shapes and colors being arranged corresponding to predetermined positions on said non-woven fabric; said pieces of assembled cloth being melted and softened by a heating roller for attaching to a first surface of said non-woven fabric; a piece of net cloth with larger meshes makes a bottom surface thereof covered with glue so that said net cloth is attached to a second surface of said pieces of assembled cloth for integrally connecting said non-woven fabric, said pieces of assembled cloth, and said net cloth with each other, which achieves effects of rapid production and nice ventilation.

2. The method as claimed in claim 1, said non-woven fabrics for said vamp is made of Thermoplastic Polyurethanes or other like Thermoplastic resin.

3. The method as claimed in claim 1, said pieces of assembled cloth are made of Thermoplastic Polyurethanes or other like Thermoplastic resin.

4. The method as claimed in claim 1, said net cloth is made of Thermoplastic Polyurethanes or other like Thermoplastic resin, thereby directly attaching said net cloth to said second surface of said pieces of assembled cloth via said heating roller so as to further integrally combine with said non-woven fabric.

5. The method as claimed in claim 1, a knit plane is formed on a junction of any two pieces of assembled cloth.

6. The method as claimed in claim 1, an overlapping bulge is formed on a junction of any two pieces of assembled cloth; said net cloth accordingly rises and falls on said pieces of assembled cloth to present a solid effect.

7. The method as claimed in claim 1, said pieces of assembled cloth in different thickness are arranged on said non-woven fabric; a knit bulge is formed on a junction of a thicker piece of assembled cloth and a thinner piece of assembled cloth; said net cloth accordingly rises and falls on said pieces of assembled cloth to present a solid effect.

8. The method as claimed in claim 1, wherein, at least one piece of assembled cloth is attached to a third surface of said net cloth.
